(19) United States
(12) Patent Application Publication
(10) Pub. No.: US 2025/0138338 A1
(43) Pub. Date: May 1, 2025

(54) Rotatable Spectacle Temple

(71) Applicant: TEAMWORKS GLASSES CORP., Tainan (TW)

(72) Inventor: Mei-Yueh Hou, Tainan (TW)

(73) Assignee: TEAMWORKS GLASSES CORP., Tainan (TW)

(21) Appl. No.: 18/495,781

(22) Filed: Oct. 27, 2023

(51) Int. Cl. G02C 5/22

(52) U.S. Cl. CPC G02C 5/2263; G02C 5/2227

(57) ABSTRACT

The present invention provides a rotatable spectacle temple, which mainly assembles two temples on a spectacle frame, wherein each of the temple includes: a fixed piece assembled on the spectacle frame; a connecting rod assembled on the fixed piece; a positioning block assembled on the connecting rod; an elastic element assembled on the connecting rod; a stopper assembled on the connecting rod; and a body assembled on the positioning block. In this way, the temples can flexibly bend outwardly, pulled upwardly or downwardly, or rotate clockwise or counterclockwise, are not easily deformed or broken, are quite flexible to wear, and are extremely comfortable.

### BACKGROUND OF THE PRESENT INVENTION

### Field of Invention

The invention relates to a rotatable spectacle temple that can flexibly bend outwardly, pulled upwardly or downwardly, or rotate clockwise or counterclockwise, is not easily deformed or broken, is quite flexible to wear, and is extremely comfortable.

### Description of Related Arts

It is noted that general glasses mainly consist of a frame and two temples. The frame is embedded with lenses, and the temples are respectively pivotally connected to the sides of the frame. When wearing glasses, it is necessary to use the pivot joint between the temples and the frame as the axis to rotate the temples outward and unfold them. The temples can only be opened to an angle of 90 degrees relative to the frame, that is, they cannot bend outwards further. They lack elasticity and cannot flexibly expand up and down or rotate left and right. Therefore, when wearing glasses or when the temples are subjected to excessive pressure, the pivot point between the temples and the frame is prone to damage, causing the temples to break and separate from the frame. This results in poor flexibility and discomfort in wearing, and is prone to deformation, so it has its shortcomings.

### SUMMARY OF THE PRESENT INVENTION

The main purpose of the present invention is to provide a rotatable spectacle temple that can be flexibly bend outwardly, pulled upwardly or downwardly, or rotate clockwise or counterclockwise, is not easily deformed or broken, is quite flexible to wear, is extremely comfortable, and can effectively solve the shortcomings of conventional spectacle temples.

A rotatable spectacle temple of the present invention, which mainly includes a spectacle frame and two temples, wherein the temples respectively contain a fixed piece, assembled on the spectacle frame, wherein the fixed piece has a second connection hole arranged on a front section thereof and a hook hole arranged on a rear section thereof; a connecting rod, assembled on the fixed piece, wherein the connecting rod has a hook arranged on a front section thereof and a limiting end arranged on a rear section thereof; a positioning block, assembled on the connecting rod, wherein the positioning block has a movable space disposed in a middle thereof, a rod hole and a hook groove respectively disposed in the movable space, a latching portion provided on a rear section thereof and penetrated by the rod hole, and a resisting end provided in the latching part; an elastic element, assembled on the connecting rod; a stopper, assembled on the connecting rod; and a body, assembled on the positioning block, wherein the body has a concave groove in a front section thereof, a rod groove in the concave groove, and a fourth connection hole in an inner side of the body and penetrating the concave groove.

The rotatable spectacle temple of the present invention, the spectacle frame has a joint portion each provided on two sides thereof, wherein the joint portion has two concave arc surfaces and a blocking edge respectively provided at a rear end thereof, a slot provided in a middle thereof, and a first connection hole provided on an inner side thereof and penetrating the slot.

The rotatable spectacle temple of the present invention, the positioning block has two convex arc surfaces and a blocking wall respectively disposed on a front end thereof, and a third connection hole provided on the latching portion that penetrates the rod hole.

The advantages of the rotatable spectacle temple of the present invention include the following: the temples can flexibly bend outwardly, pulled upwardly or downwardly, or rotate clockwise or counterclockwise, are not easily deformed or broken, are quite flexible to wear, and are extremely comfortable.

### BRIEF DESCRIPTION OF THE DRAWINGS

FIG. 1 is an exploded view of an embodiment of the present invention.

FIG. 2 is an assembling view of an embodiment of the present invention.

FIG. 3 is an assembling sectional view of an embodiment of the present invention.

FIG. 4 is a sectional view of the temple bend outwardly according to an embodiment of the present invention.

FIG. 5 is a sectional view of the temple pulled upwardly or downwardly according to an embodiment of the present invention.

FIG. 6 is a sectional view (1) of the temple rotate clockwise or counterclockwise according to the embodiment of the present invention.

FIG. 7 is a perspective view (2) of the temple rotate clockwise or counterclockwise according to the embodiment of the present invention.

### DETAILED DESCRIPTION OF THE PREFERRED EMBODIMENT

A preferred embodiment with drawings is provided in detail to illustrate a feasible technical means of the present invention in achieving the above and other uses and functions.

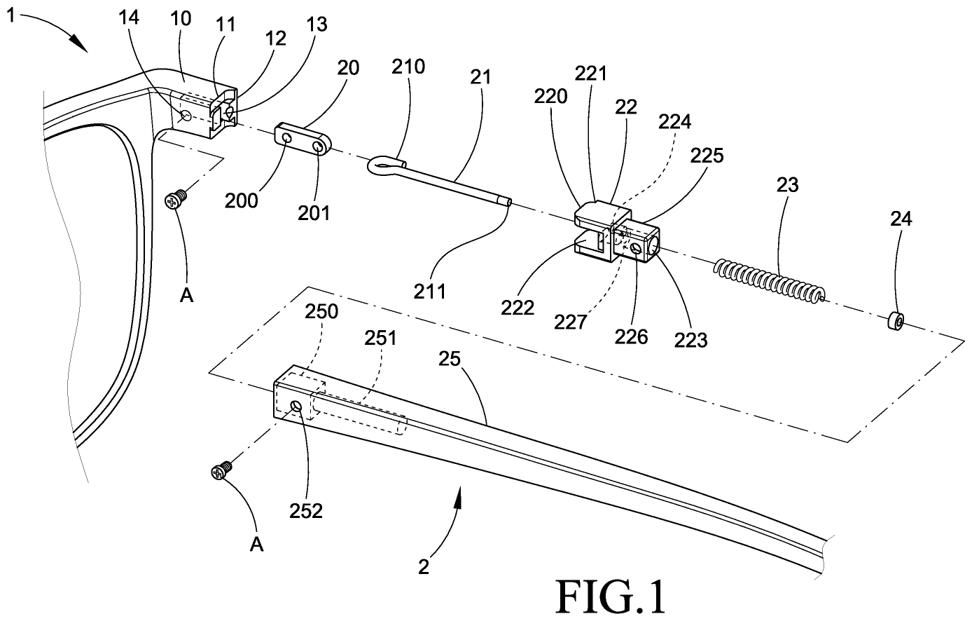

The embodiment of the present invention, referring to FIG. 1, a spectacle mainly includes a spectacle frame 1 and two temples 2 arranged on the spectacle frame 1. The spectacle frame 1 has a joint portion 10 each provided on two sides thereof. The joint portion has two concave arc surfaces 11 and a blocking edge 12 respectively provided at a rear end thereof, a slot 13 provided in a middle thereof, and a first connection hole 14 provided on an inner side thereof and penetrating the slot 13. The temple 2 includes: a fixed piece 20, assembled on the spectacle frame 1, wherein the fixed piece 20 has a second connection hole 200 arranged on a front section thereof and a hook hole 201 arranged on a rear section thereof; a connecting rod 21, assembled on the fixed piece 20, wherein the connecting rod 21 has a hook 210 arranged on a front section thereof and a limiting end 211 arranged on a rear section thereof; a positioning block 22, assembled on the connecting rod 21, wherein the positioning block 22 has two convex arc surfaces 220 and a blocking wall 221 respectively disposed on a front end thereof, a movable space 222 disposed in a middle thereof, a rod hole 223 and a hook groove 224 respectively disposed in the movable space 222, a latching portion 225 provided on a rear section thereof and penetrated by the rod hole 223, a third connection hole 226 provided on the latching portion 225 that penetrates the rod hole 223, and a resisting end 227 provided in the latching part 225; an elastic element 23, assembled on the connecting rod 21; a stopper 24, assembled on the connecting rod 21; and a body 25, assembled on the positioning block 22, wherein the body 25 has a concave groove 250 in a front section thereof, a rod groove 251 in the concave groove 250, and a fourth connection hole 252 in an inner side of the body 25 and penetrating the concave groove 250. In this way, it is a rotatable spectacle temple.

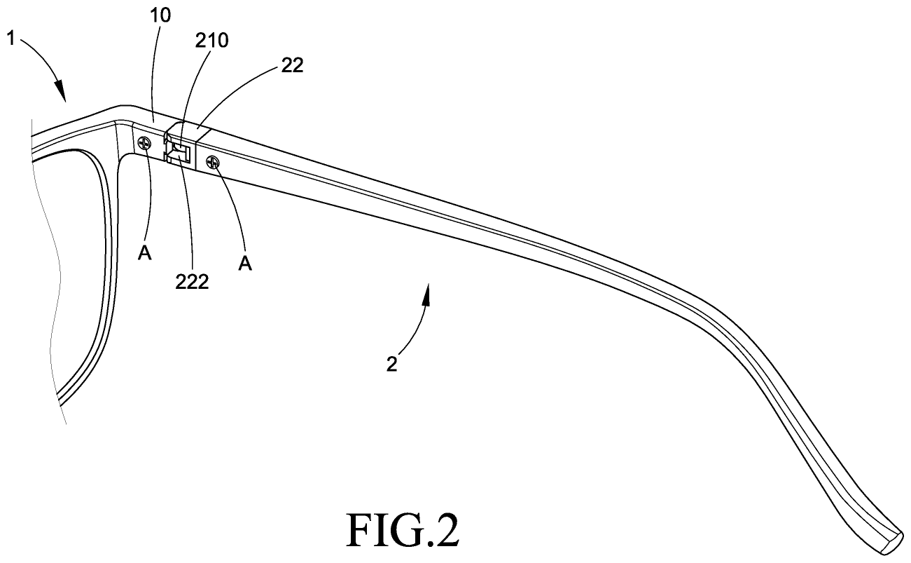

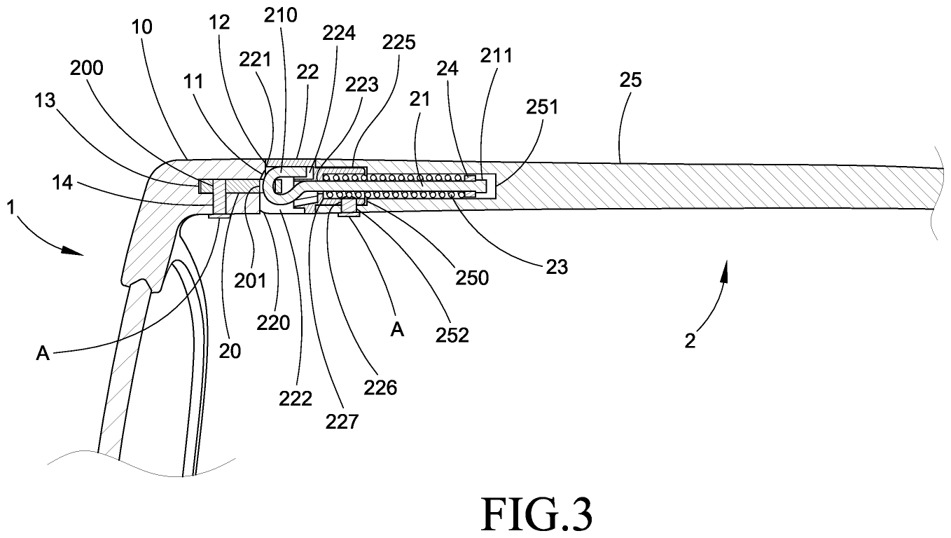

When assembling, referring to FIGS. 1-3. First, insert the fixed piece 20 into the slot 13 of the spectacle frame 1 so that the second connection hole 200 of the fixed piece 20 corresponds to the first connection hole 14 of the spectacle frame 1, and use a screw component A to fix the fixed piece 20. Then, hook the hook 210 of the connecting rod 21 into the hook hole 201 of the fixed piece 20, and thread the connecting rod 21 through the rod hole 223 of the positioning block 22. The end of the hook 210 of the connecting rod 21 is arranged in the hook groove 224 of the positioning block 22. The two convex arc surfaces 220 and the blocking wall 221 of the positioning block 22 correspond to the two concave arc surfaces 11 and blocking edge 12 of the spectacle frame 1. And then, assemble the elastic element 23 on the connecting rod 21, wherein one end of the elastic element 23 is inserted into the rod hole 223 of the positioning block 22 and abuts against the resisting end 227. Next, assemble the stopper 24 on the connecting rod 21, so that the stopper 24 is against the other end of the elastic element 23, and the stopper 24 is fixed on the connecting rod 21. The limiting end 211 can be a flattened limit. Further, insert the latching portion 225 of the positioning block 22 into the concave groove 250 of the body 25, so that the third connection hole 226 on the latching portion 225 corresponds to the fourth connection hole 252, and the rod groove 251 of the body 25 is inserted into the connecting rod 21, the elastic element 23 and the stopper 24. Finally, another screw component A is used to fix the positioning block 22, so that the overall assembly can be completed.

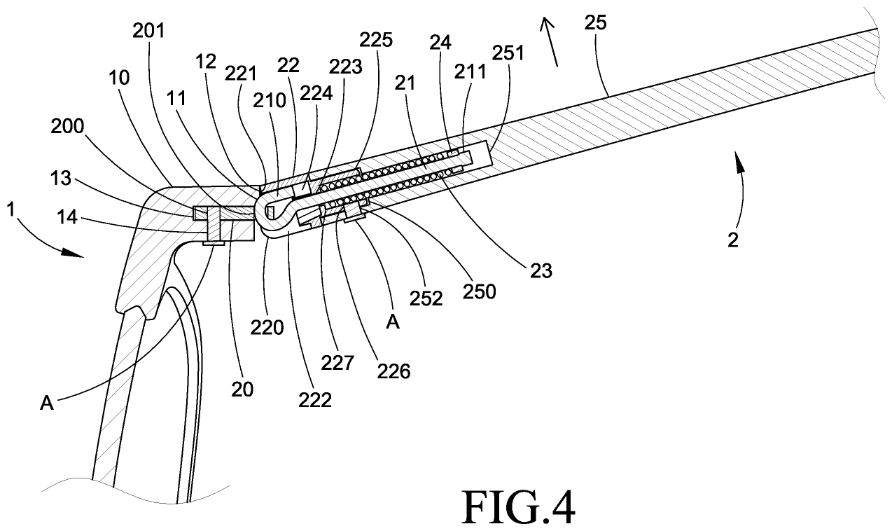

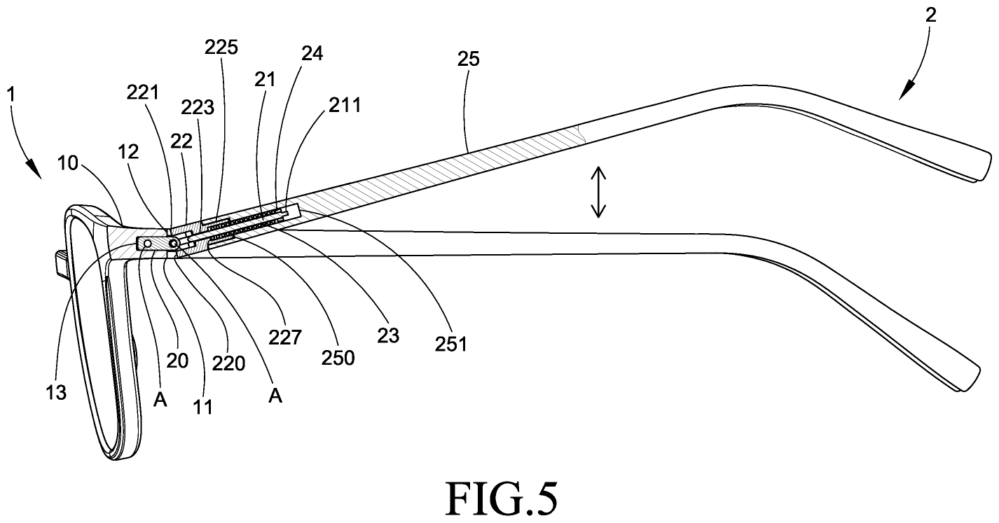

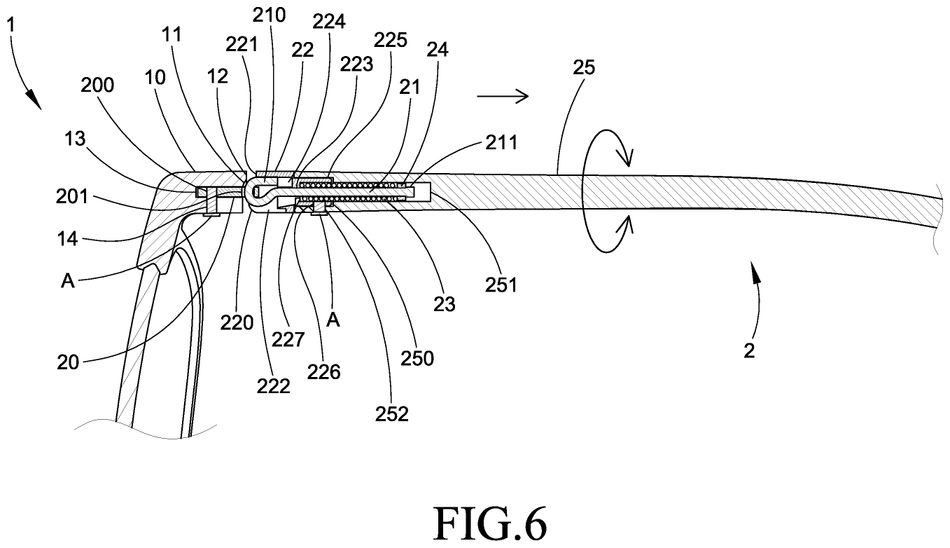

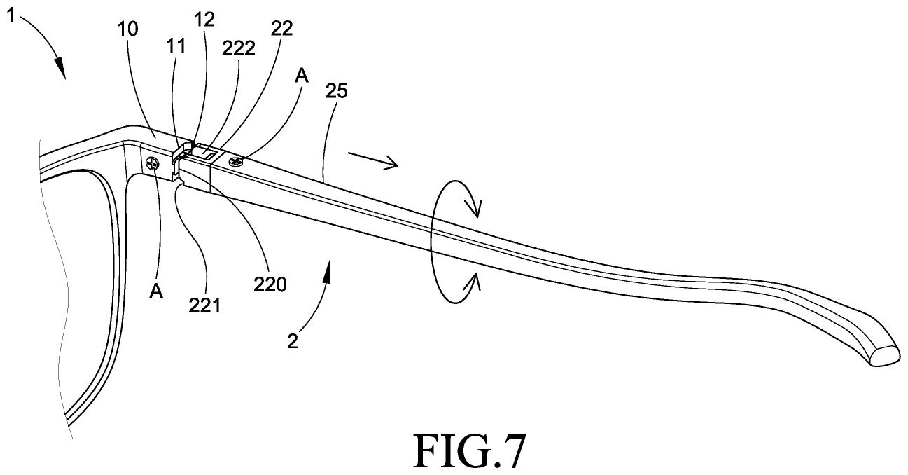

When using, referring to FIGS. 4-7. When the user holds the body 25 to adjust the wearing angle, the body 25 can flexibly bend outwardly, pulled upwardly or downwardly, or rotate clockwise or counterclockwise. The convex arc surfaces 220 of the positioning block 22 correspond to the concave arc surfaces 11 of the spectacle frame 1 and can move along the concave arc surfaces 11. The blocking wall 221 of the positioning block 22 corresponds to the blocking edge 12 of the spectacle frame 1 and can prevent excessive extension appropriately. The elastic element 23 is in a compressed state. After the user finishes wearing, the convex arc surfaces 220 of the positioning block 22 also correspond to the concave arc surfaces 11 of the spectacle frame 1 and can move along the concave arc surfaces 11. The elastic element 23 is in a returned state. In addition, when the user holds the spectacle frame 1 and the body 25 and pulls the body 25 backward, the convex arc surfaces 220 and the blocking wall 221 of the positioning block 22 no longer correspond to the concave arc surfaces 11 and the blocking edge 12 of the spectacle frame 1, and the end of the hook 210 of the connecting rod 21 is separated from the hook groove 224 of the positioning block 22. The elastic element 23 is in the compressed state. The main body 25 can be flexibly rotated left and right for flexible wearing until the convex arc surfaces 220 and the blocking wall 221 of the positioning block 22 once again correspond to the concave arc surfaces 11 and the blocking edge 12 of the spectacle frame 1. The user no longer pulls the body 25 backward, the end of the hook 210 of the connecting rod 21 is arranged in the hook groove 224 of the positioning block 22. The elastic element 23 is in the returned state. Through the characteristics of the elastic element 23, it can effectively prevent deformation or breakage of the body 25. In this way, the temples can flexibly bend outwardly, pulled upwardly or downwardly, or rotate clockwise or counterclockwise without easily deforming or breaking, and the wear is quite flexible and comfortable.

In summary, the present invention has achieved the expected objects and effects, and is more ideal and practical than prior art. However, the above-mentioned embodiments are only for specifically describing the preferred embodiments of the present invention, and the embodiments are not intended to limit the scope of the present application. Also, other equivalent changes and modifications made without departing from the technical means disclosed in the present invention are intended to be included in the patent scope of the present invention.

What is claimed is:

1. A rotatable spectacle temple, which mainly assembles two temples on a spectacle frame, wherein the temple comprises:
a fixed piece, assembled on the spectacle frame, wherein the fixed piece has a second connection hole arranged on a front section thereof and a hook hole arranged on a rear section thereof;
a connecting rod, assembled on the fixed piece, wherein the connecting rod has a hook arranged on a front section thereof and a limiting end arranged on a rear section thereof;
a positioning block, assembled on the connecting rod, wherein the positioning block has a movable space disposed in a middle thereof, a rod hole and a hook groove respectively disposed in the movable space, a latching portion provided on a rear section thereof and penetrated by the rod hole, and a resisting end provided in the latching part;
an elastic element, assembled on the connecting rod;
a stopper, assembled on the connecting rod; and
a body, assembled on the positioning block, wherein the body has a concave groove in a front section thereof, a rod groove in the concave groove, and a fourth connection hole in an inner side of the body and penetrating the concave groove.

2. The rotatable spectacle temple, as recited in claim 1, wherein the spectacle frame has a joint portion each provided on two sides thereof, wherein the joint portion has two concave arc surfaces and a blocking edge respectively provided at a rear end thereof, a slot provided in a middle thereof, and a first connection hole provided on an inner side thereof and penetrating the slot.

3. The rotatable spectacle temple, as recited in claim 1, wherein the positioning block has two convex arc surfaces and a blocking wall respectively disposed on a front end thereof, and a third connection hole provided on the latching portion that penetrates the rod hole.
